(19) United States
(12) Patent Application Publication
(10) Pub. No.: US 2026/0010118 A1
(43) Pub. Date: Jan. 8, 2026

(54) IMAGE FORMING APPARATUS

(71) Applicant: CANON KABUSHIKI KAISHA, Tokyo (JP)

(72) Inventor: JIRO YAMADA, Kanagawa (JP)

(21) Appl. No.: 19/256,664

(22) Filed: Jul. 1, 2025

(30) Foreign Application Priority Data
Jul. 5, 2024 (JP) 2024-109144

(51) Int. Cl. G03G 21/18; G03G 21/16

(52) U.S. Cl. CPC G03G 21/186; G03G 21/1619; G03G 21/1633; G03G 21/1647; G03G 21/1814; G03G 2221/1606; G03G 2221/1657

(57) ABSTRACT

An image forming apparatus includes a detachable unit including a driven member, and an apparatus body to which the detachable unit is detachably attached. The apparatus body includes a driving-force transmission portion including an engagement member, a support portion including an extending surface, a brake portion configured to generate brake force that applies load to rotation of the driven member, and a brake-force applying portion including a through member and a brake engagement member, the brake-force applying portion being configured to apply the brake force to the driven member via the through member and the brake engagement member by the brake engagement member engaging with the driven member. The brake portion is disposed opposite the driving-force transmission portion across the extending surface in the axis direction.

### BACKGROUND

### Field of the Technology

The present disclosure relates to an image forming apparatus that forms images on sheets.

### Description of the Related Art

In general, an image forming apparatus that uses the electrophotographic process has a known configuration in which a photosensitive drum and process portions that perform operations on the photosensitive drum are integrated with each other and formed as a cartridge. The cartridge can be attached to and detached from the apparatus body of the image forming apparatus. The cartridge is joined with the apparatus body by using a coupling, so that the driving force is applied from the apparatus body to the photosensitive drum.

Japanese Patent Application Publication No. 2020-154313 proposes an image forming apparatus that includes a driving-force transmission unit and a brake member. The driving-force transmission unit is disposed in a coupling portion of the apparatus body, and transmits the driving force to the photosensitive drum. The brake member is disposed in the driving-force transmission unit. In a case where the driving torque necessary for rotating the photosensitive drum has a low value, the variations in speed easily occur in the photosensitive drum if the photosensitive drum is affected by the surroundings when rotated. For this reason, in the image forming apparatus, the rotation of the photosensitive drum is stabilized by rotating the photosensitive drum in a state where a constant level of load is applied to the photosensitive drum by the brake member.

However, in Japanese Patent Application Publication No. 2020-154313, since the brake member is disposed in a space surrounded by a driving gear and a drum driving coupling of the driving-force transmission unit, there is a problem in maintainability of the brake member.

### SUMMARY

According to one aspect of the present disclosure, an image forming apparatus includes a detachable unit including a driven member configured to rotate, and an apparatus body to which the detachable unit is detachably attached. The apparatus body includes a driving-force transmission portion configured to transmit driving force to the driven member, and including an engagement member, the engagement member being configured to rotate about a rotation axis extending in an axis direction and to engage with the driven member, a support portion configured to support the driving-force transmission portion so that the driving-force transmission portion is rotatable, and including an extending surface extending in an intersecting direction that intersects the axis direction, a brake portion configured to generate brake force that applies load to rotation of the driven member, and a brake-force applying portion including a through member extending from one side of the extending surface to the other side of the extending surface in the axis direction, and a brake engagement member configured to engage with the driven member, the brake-force applying portion being configured to apply the brake force to the driven member via the through member and the brake engagement member by the brake engagement member engaging with the driven member. The brake portion is disposed opposite the driving-force transmission portion across the extending surface in the axis direction.

Features of the present disclosure will become apparent from the following description of embodiments with reference to the attached drawings. The following description of embodiments is described by way of example.

### BRIEF DESCRIPTION OF THE DRAWINGS

FIG. 1 is an overall schematic diagram illustrating a printer of a first embodiment.

FIG. 2 is a schematic diagram illustrating the printer in a state where a door is opened.

FIG. 3 is a perspective view illustrating a cartridge.

FIG. 4 is an enlarged perspective view illustrating a drum coupling.

FIG. 5A is an exploded perspective view illustrating a main-body coupling mechanism.

FIG. 5B is an exploded perspective view illustrating a first brake-engagement member, a second brake-engagement member, and a brake transmission member.

FIG. 6 is a cross-sectional view illustrating the main-body coupling mechanism.

FIG. 7A is a perspective view illustrating a drum driving coupling.

FIG. 7B is a perspective view illustrating the drum driving coupling and coupling engagement portions.

FIG. 7C is a perspective view illustrating a state where the coupling engagement portions rotate in a through-hole.

FIG. 8 is a cross-sectional view illustrating a state where the main-body coupling mechanism and the drum coupling are engaged with each other.

FIG. 9 is an enlarged cross-sectional view illustrating a vicinity of a projection portion of the drum coupling.

FIG. 10 is a cross-sectional view illustrating a main-body coupling mechanism of a second embodiment.

### DESCRIPTION OF THE EMBODIMENTS

Hereinafter, some embodiments of the present disclosure will be described with reference to the accompanying drawings. Note that the size, material, shape, and relative arrangement of components described in the embodiments may be changed as appropriate in accordance with the configuration of an apparatus for which the present disclosure is applied, and with various conditions. That is, the scope of the present disclosure is not limited to the below-described embodiments.

### First Embodiment

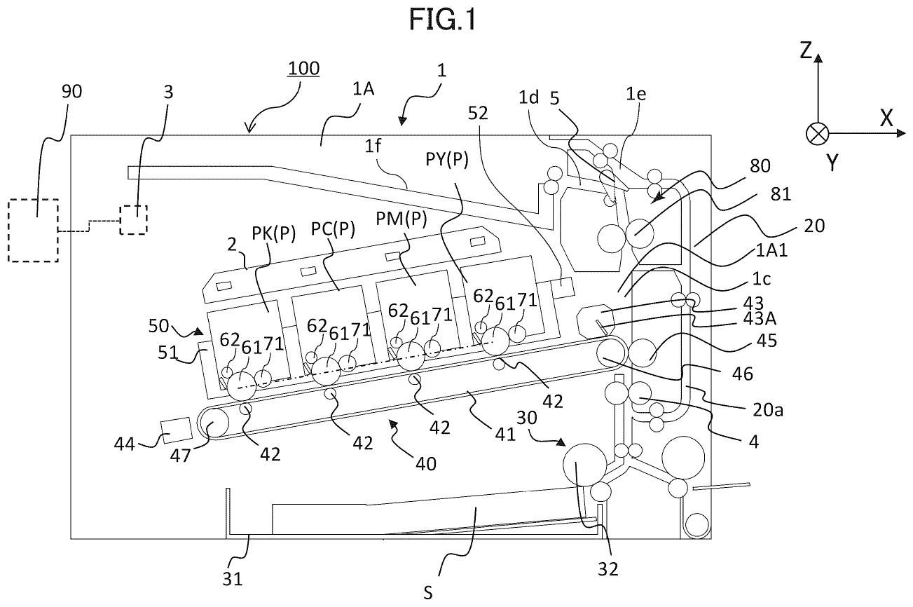

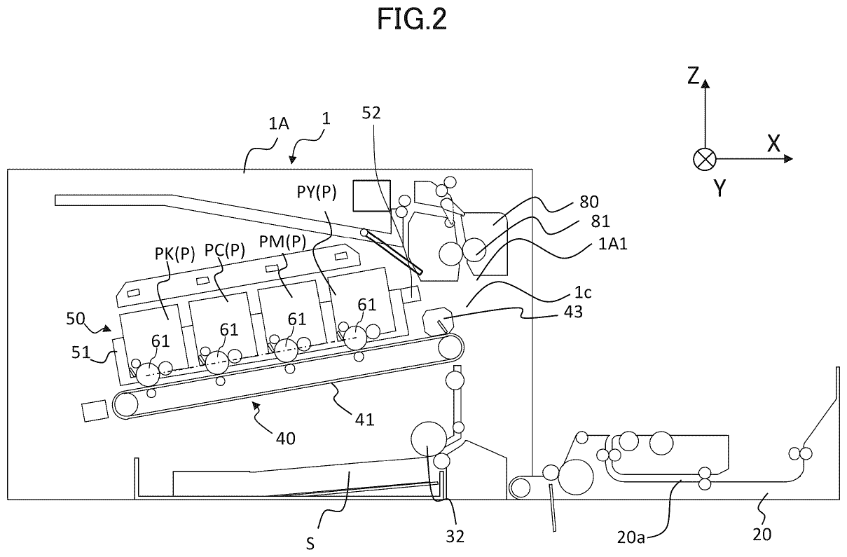

First, a printer 1 that serves as an image forming apparatus of a first embodiment will be described with reference to FIG. 1. FIG. 1 is a schematic diagram illustrating an overall configuration of the printer 1 of the present embodiment. FIG. 2 is a schematic diagram illustrating the printer 1 in a state where a door 20 is opened. The printer 1 is an electrophotographic color laser beam printer that forms an image on a sheet S that serves as a recording material.

In the following description and the drawings, a vertical direction in a case where the printer 1 is placed on a horizontal plane is defined as a Z-axis direction. The rotation-axis direction of a photosensitive drum 61 included in the printer 1 is defined as a Y-axis direction. In addition, a direction that intersects both of the Z-axis direction and the Y-axis direction is defined as an X-axis direction. Preferably, the X-axis direction, the Y-axis direction, and the Z-axis direction are orthogonal to each other. In addition, there is a case where one side of the X-axis direction (i.e., the side indicated by an X arrow) is referred to as a +X side or a +X direction, and where the other side of the X-axis direction is referred to as a −X side or a −X direction. Similarly, there is a case where one side of the Y-axis direction (i.e., the side indicated by a Y arrow) is referred to as a +Y side or a +Y direction, and where the other side of the Y-axis direction is referred to as a −Y side or a −Y direction. Furthermore, there is a case where one side of the Z-axis direction (i.e., the side indicated by a Z arrow) is referred to as a +Z side or a +Z direction, and where the other side of the Z-axis direction is referred to as a −Z side or a −Z direction.

The +X direction may be referred to as a front surface side (front side) of the printer 1. In addition, the +Y side viewed from the front surface side of the printer 1 may be referred to as a right side, and the −Y side viewed from the front surface side of the printer 1 may be referred to as a left side.

As illustrated in FIG. 1, the printer 1 includes an apparatus body 1A (casing), a scanner 2 that serves as an exposure apparatus, a control portion 3, and the door 20 that serves as an opening-and-closing member. In addition, the printer 1 includes a sheet feeding portion 30, a transfer unit 40, a tray unit (detachable unit) 50, and a fixing apparatus 80. A portion that includes the apparatus body 1A and the door 20 may be referred to as a mainframe 100 of the printer 1. The mainframe 100 includes an exterior portion of the printer 1. The apparatus body 1A accommodates the scanner 2, the control portion 3, the sheet feeding portion 30, the transfer unit 40, a secondary transfer roller 45, the tray unit 50, and the fixing apparatus 80.

The sheet feeding portion 30 includes a stacking tray 31 that stacks the sheet S that serves as a recording material, and a feeding roller 32 that serves as a feeding member that feeds the sheet S. The stacking tray 31 can be drawn toward the door 20, and the sheet S can be supplied to the stacking tray 31. In the present embodiment, the opening direction of the door 20 and the drawing direction of the stacking tray 31 are the same as each other, and are the +X side.

The tray unit 50 includes a tray 51 (support member, drawer) and cartridges PY, PM, PC, and PK. The tray 51 includes a tray handle 52 (holding portion). The cartridges PY, PM, PC, and PK are detachably (removably) attached to the tray 51.

The cartridges PY, PM, PC, and PK can be detachably attached to the tray 51 independently of each other. The cartridges PY, PM, PC, and PK respectively contain toner (developer) of yellow (Y), magenta (M), cyan (C), and black (K). The cartridges PY, PM, PC, and PK have configurations identical to each other, except that the colors of toner contained in the cartridges are different from each other. Thus, the configuration and operation of any one of the cartridges PY, PM, PC, and PK will be described, and the description for the other cartridges may be omitted. In addition, in a case where the cartridges PY, PM, PC, and PK need not to be distinguished from each other, each of the cartridges PY, PM, PC, and PK may be simply referred to as a cartridge P. Thus, the tray unit 50, in other words, includes a plurality of cartridges P, and the tray 51 to which the plurality of cartridges Pis detachably attached.

In the present embodiment, the tray unit 50 includes a plurality of photosensitive drums (image bearing members) 61, a plurality of charging rollers (charging members) 62, and a plurality of developing rollers (developing members, developer bearing members) 71. Specifically, the tray unit 50 includes four photosensitive drums 61, four charging rollers 62, and four developing rollers 71. The rotation-axis direction of each photosensitive drum 61, the rotation-axis direction of each developing roller 71, and the rotation-axis direction of each charging roller 62 are substantially parallel to each other.

A portion of the tray unit 50 that forms a black image can be called a black station (first station); and the photosensitive drum 61, the developing roller 71, and the charging roller 62 of the first station can respectively be called a first photosensitive drum, a first developing roller, and a first charging roller. A portion of the tray unit 50 that forms a cyan image can be called a cyan station (second station); and the photosensitive drum 61, the developing roller 71, and the charging roller 62 of the second station can respectively be called a second photosensitive drum, a second developing roller, and a second charging roller. A portion of the tray unit 50 that forms a magenta image can be called a magenta station (third station); and the photosensitive drum 61, the developing roller 71, and the charging roller 62 of the third station can respectively be called a third photosensitive drum, a third developing roller, and a third charging roller. A portion of the tray unit 50 that forms a yellow image can be called a yellow station (fourth station); and the photosensitive drum 61, the developing roller 71, and the charging roller 62 of the fourth station can respectively be called a fourth photosensitive drum, a fourth developing roller, and a fourth charging roller.

The cartridge PK attached to the tray 51 constitutes at least a portion of the black station. The cartridge PC attached to the tray 51 constitutes at least a portion of the cyan station. The cartridge PM attached to the tray 51 constitutes at least a portion of the magenta station. The cartridge PY attached to the tray 51 constitutes at least a portion of the yellow station. The cartridges PK, PC, PM, and PY may respectively be referred to as a first cartridge, a second cartridge, a third cartridge, and a fourth cartridge. Note that the ordinal numbers, such as first, second, third, and fourth, described above are used for convenience of description.

The photosensitive drum 61, the charging roller 62, and the developing roller 71 have only to be included in any one of the cartridge P and the tray 51. In the present embodiment, the cartridge P includes the photosensitive drum 61, the charging roller 62, and the developing roller 71.

The transfer unit 40 includes a belt 41, primary transfer rollers 42, a cleaning portion 43, a driving roller 46 that drives the belt 41, and a tension roller 47. In addition, in the printer 1, an optical sensor 44 that detects a toner image transferred to the belt 41 is disposed. In the present embodiment, the belt 41 is disposed below the photosensitive drum 61, and is in contact with the photosensitive drum 61 so that a primary transfer portion is formed between the belt 41 and the photosensitive drum 61.

In addition, the printer 1 includes the secondary transfer roller 45 that is in contact with the belt 41 so that a secondary transfer portion is formed. The secondary transfer portion is formed between the belt 41 and the secondary transfer roller 45. The rotation-axis direction of the primary transfer rollers 42, the rotation-axis direction of the driving roller 46, the rotation-axis direction of the tension roller 47, and the rotation-axis direction of the secondary transfer roller 45 are substantially parallel with each other. In addition, a registration roller pair 4 is disposed upstream of the secondary transfer portion in the conveyance direction of the sheet S.

The fixing apparatus 80 includes a fixing portion 81 and a switching guide 5. The fixing apparatus 80 of the present embodiment can move with respect to the apparatus body 1A, between a use position and a retracted position. In a case where an image forming operation is performed, the fixing apparatus 80 is in the use position. In a state where the fixing apparatus 80 is in the use position, the fixing apparatus 80 is accommodated in the interior (inside) of the apparatus body 1A. In addition, the fixing apparatus 80 heats the sheet S in a state where the fixing apparatus 80 is in the use position. The fixing portion 81 includes a heating portion (heating roller) that includes a heater (heat source), and a pressing portion (pressing roller) that, together with the heating portion, forms a fixing nip.

As illustrated in FIG. 2, the apparatus body 1A includes an opening 1A1 in an end portion on the +X side. The door 20 is an opening-and-closing member (cover member, front cover) that can move with respect to the apparatus body 1A, between a closing position and an opening position. As illustrated in FIG. 1, in a state where the door 20 is in the closing position, the door 20 covers the opening 1A1. As illustrated in FIG. 2, in a state where the door 20 is in the opening position, the opening 1A1 is exposed to the outside of the apparatus body 1A. In a state where the door 20 is in the closing position, the printer 1 performs the below-described image forming operation. In a state where the door 20 is in the opening position, the tray unit 50 and the transfer unit 40 are allowed to be drawn from the apparatus body 1A through the opening 1A1. Note that the tray unit 50 can be drawn from the apparatus body 1A by a user pulling the tray handle 52 of the tray 51. In a state where the tray 51 is drawn from the apparatus body 1A, the cartridge P can be separated from the tray 51.

That is, the cartridge P can be regarded as an detachable unit that can be detached from the apparatus body 1A. In addition, the tray unit 50 can also be regarded as an detachable unit that can be detached from the apparatus body 1A. A below-described drum unit 68 disposed in the cartridge P is an example of a driven member that is rotatably disposed.

For allowing the opening 1A1 to be exposed widely, the fixing apparatus 80 can move (retract) from the use position illustrated in FIG. 1, to the retracted position retracted upward from the use position. In a state where the door 20 is moved to the opening position and the fixing apparatus 80 is moved to the retracted position, the transfer unit 40 and the tray unit 50 can be moved from the inside to the outside of the apparatus body 1A through the opening 1A1.

### Image Forming Operation

Next, an image forming operation will be described with reference to FIG. 1. The image forming operation is a series of operations in which the printer 1 forms an image on the sheet S while conveying the sheet S. The control portion 3 of the printer 1 starts the image forming operation, based on the image information sent from an external host apparatus 90. For example, the external host apparatus 90 is a personal computer, an image reader, a facsimile, or the like.

If the image forming operation is started, the photosensitive drum 61 is driven and rotated, and the charging roller 21 applied with a charging voltage uniformly charges the surface of the photosensitive drum 61, in each station of the tray unit 50. In addition, a laser beam that corresponds to the image information is emitted from the scanner 2 to each photosensitive drum 61, so that the surface of the photosensitive drum 61 is exposed. With this exposure, an electrostatic latent image is formed on the surface of the photosensitive drum 61. The electrostatic latent image corresponds to an image obtained by decomposing the image information into a corresponding one of CMYK color components.

The developing roller 71 rotates while bearing the toner. The developing roller 71 is applied with a developing voltage, and the electrostatic latent image formed on the photosensitive drum 61 is developed by the toner supplied from the developing roller 71. As a result, a toner image is formed on the surface of the photosensitive drum 61. In the present embodiment, the developing roller 71 develops the electrostatic latent image in a state where the developing roller 71 is in contact with the photosensitive drum 61 (contact developing system). However, another system may be used. For example, the developing roller 71 may develop the electrostatic latent image in a state where a clearance is formed between the developing roller 71 and the photosensitive drum 61. In a case where a full-color image is formed, a toner image of each color is formed on a corresponding photosensitive drum 61.

Note that in the present embodiment, the developing roller 71 can move between an abutment position in which the developing roller 71 is in contact with the photosensitive drum 61, and a separation position in which the developing roller 71 is separated from the photosensitive drum 61. Specifically, the state where the developing roller 71 is positioned in the abutment position and the state where the developing roller 71 is positioned in the separation position is switched by a switching apparatus included in the apparatus body 1A. Thus, in a state where the image forming operation is not performed, the developing roller 71 can be separated from the photosensitive drum 61.

In addition, the printer 1 can perform monochrome printing in a state where the developing roller 71 and the photosensitive drum 61 of the cartridge PK are in contact with each other, and where the developing roller 71 and the photosensitive drum 61 of each of the cartridges PY, PM, and PC are not in contact with each other. In addition, the printer 1 can perform full-color printing in a state where the photosensitive drum 61 of each of the cartridges PY, PM, PC, and PK and the belt 41 are in contact with each other.

The toner image formed on each photosensitive drum 61 is transferred to the belt 41 by a corresponding primary transfer roller 42, in the primary transfer portion. The toner image is conveyed, while borne by the belt 41, toward the secondary transfer portion formed by the belt 41 and the secondary transfer roller 45.

In the apparatus body 1A, a conveyance path 1c (first path, first conveyance path) is formed, and extends from the feeding roller 32 toward the fixing apparatus 80 through the secondary transfer portion. In the door 20, a duplex conveyance path (second path, second conveyance path) 20a is formed. The duplex conveyance path 20a is a path through which the sheet S that has passed through the fixing apparatus 80 passes. In a state where the door 20 is closed, the door 20 covers the conveyance path 1c. As illustrated in FIG. 2, if the door 20 is opened, at least a portion of the conveyance path 1c and at least a portion of the duplex conveyance path 20a are exposed to the outside of the apparatus body 1A.

In the image forming operation, in parallel with the above-described formation of a toner image, the sheet S is fed, one by one, from the sheet feeding portion 30 toward the secondary transfer portion through the conveyance path 1c. Specifically, an uppermost sheet of sheets S stacked on the stacking tray 31 is fed by the feeding roller 32 at a predetermined timing. The fed sheet S is separated from other sheets by a separation member, such as a friction roller; and the skew correction and timing adjustment are performed on the sheet S by the registration roller pair 4. After that, the sheet S is sent into the secondary transfer portion by the registration roller pair 4. In the secondary transfer portion, the toner image is transferred from the belt 41 to the sheet S by the secondary transfer roller 45 applied with a voltage. The toner that has not been transferred to the sheet S is removed from the belt 41 by a cleaning blade 43A (cleaning member) disposed in the cleaning portion 43.

The sheet S to which the toner image has been transferred in the secondary transfer portion is conveyed to the fixing apparatus 80. In the fixing portion 81, the sheet S is heated and pressed, so that the toner image is fixed to the sheet S. The sheet S that has passed through the fixing portion 81 reaches the switching guide 5 that serves as a path switching portion.

The switching guide 5 can move between a sheet discharging position and a reversing position. The sheet discharging position is a position in which the switching guide 5 guides the sheet S that has passed through the fixing apparatus 80, toward a discharging path 1d. The reversing position is a position in which the switching guide 5 guides the sheet S that has passed through the fixing apparatus 80, toward a reversing path 1e. In a case where the single-side printing is performed for forming an image on one side of the sheet S, the sheet S is guided to the discharging path 1d by the switching guide 5, and is discharged to a discharging tray 1f formed in an upper portion of the apparatus body 1A.

On the other hand, in a case where the double-side printing is performed for forming images on one side and the back side of the sheet S, the sheet S is guided to the reversing path 1e by the switching guide 5. After the sheet S is guided to the reversing path 1e, the conveyance direction of the sheet S is reversed, and the sheet S is conveyed toward the secondary transfer portion through the duplex conveyance path 20a formed in the door 20. After that, a toner image is transferred to the back side of the sheet S in the secondary transfer portion. Then the sheet S passes through the fixing apparatus 80, is guided to the discharging path 1d by the switching guide 5, and is discharged to the discharging tray 1f of the apparatus body 1A.

As described above, in the closing position, the door 20 covers the opening 1A1 and at least a portion of the conveyance path 1c of the sheet S. The door 20 includes the duplex conveyance path 20a. If the sheet S is stuck (which is hereinafter referred to as jam), a user of the printer 1 can eliminate the jam by removing the sheet S from one end side (i.e., the +X side) of the apparatus body 1A. Specifically, a user can remove the sheet S by accessing the interior of the apparatus body 1A, by moving the door 20 to the opening position. If a portion of the sheet S that has passed through the fixing apparatus 80 is exposed to the outside of the apparatus body 1A, a user can remove the sheet S by pulling the sheet S from the outside of the apparatus body 1A, without opening the door 20.

Furthermore, a user of the printer 1 can move the transfer unit 40 and the tray unit 50 to the outside of the apparatus body 1A, from the one end side of the apparatus body 1A, and thereby can perform various types of work, such as condition check, maintenance, and replacement on the transfer unit 40 and the cartridge P.

That is, in the printer 1, the fixing apparatus 80 is disposed on one end side of the apparatus body 1A, and the transfer unit 40 and the tray unit 50 can be moved to the outside and inside of the apparatus body 1A through the one end side of the apparatus body 1A. Thus, a user can eliminate the jam, access the fixing apparatus 80, and operate the transfer unit 40 and the tray unit 50, from one direction.

In the printer 1 of the present embodiment, the front surface is on the door 20 side (i.e., the +X side). Thus, it is only necessary to secure the space for performing various types of work, such as eliminating the jam and operating the transfer unit 40 and the tray unit 50, from the front-surface side of the printer 1. Thus, any space for performing the work from the left-surface side, the right-surface side, the back-surface side, or the top-surface side of the printer 1 may not be secured. As a result, the printer 1 can be installed, with the space saved.

If the transfer unit 40 or the tray unit 50 is drawn from the other end side of the apparatus body 1A, a user has to access both end sides of the apparatus body 1A for eliminating the jam and drawing the transfer unit 40 or the tray unit 50. In addition, if one of the transfer unit 40 and the tray unit 50 is drawn from one end side of the apparatus body 1A and the other of the transfer unit 40 and the tray unit 50 is drawn from the other end side, a user also has to access both end sides of the apparatus body 1A. Thus, not only the space for performing work from the front-surface side of the apparatus body 1A, but also the space for performing work from the back-surface side of the apparatus body 1A becomes necessary, so that the area for installing the printer 1 increases.

In addition, in the present embodiment, the sheet S can be supplied from one end side of the apparatus body 1A. Thus, it is only necessary to secure the space for supplying the sheet S from the front-surface side. As a result, the printer 1 can be installed, with the space saved.

### Cartridge

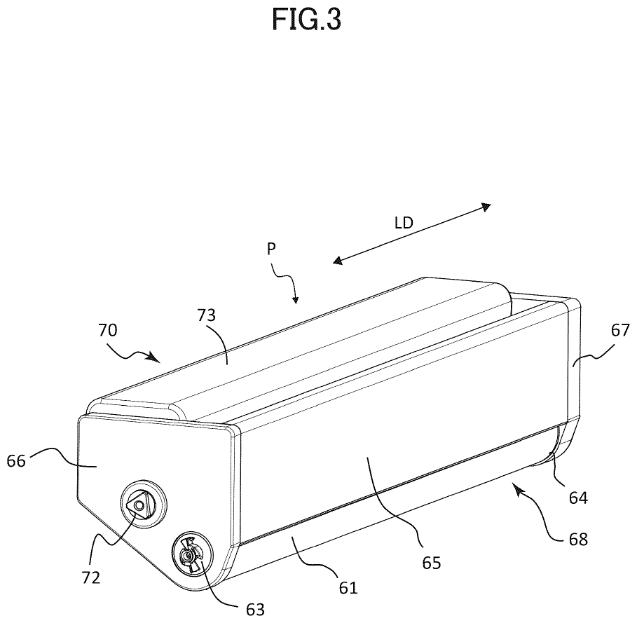

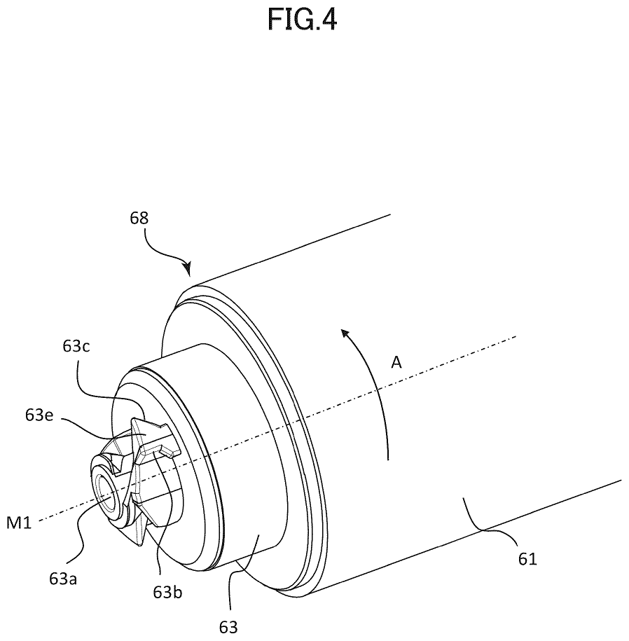

Next, a configuration of the cartridge P will be described with reference to FIGS. 3 and 4. FIG. 3 is a perspective view illustrating the cartridge P that is a process cartridge. FIG. 4 is an enlarged perspective view illustrating a drum coupling 63.

As illustrated in FIG. 3, the cartridge P includes a drum unit 68 and a developing unit 70. In addition, the cartridge P includes a first side cover 66 and a second side cover 67 that are fixed to both ends of the drum unit 68 and the developing unit 70 in a longitudinal direction LD of the cartridge P. The developing unit 70 is rotatably supported by the first side cover 66 and the second side cover 67.

The drum unit 68 is constituted by the photosensitive drum 61, the charging roller 62, a drum frame 65, and the like. In addition, the drum coupling 63 and a drum flange 64 are fixed to the photosensitive drum 61. The photosensitive drum 61, the drum coupling 63, and the drum flange 64 constitute a drum unit 68 that serves as a driven member. The drum coupling 63 is rotatably supported by the first side cover 66, and the drum flange 64 is rotatably supported by the second side cover 67. That is, the photosensitive drum 61 is rotatably supported by the first side cover 66 and the second side cover 67, via the drum coupling 63 and the drum flange 64.

Note that in the present embodiment, a cleaning unit (e.g., a cleaning blade) for removing the remaining toner that remains on the surface of the photosensitive drum 61 is not disposed in the drum unit 68. However, the present disclosure is not limited to this. For example, the above-described cleaning unit may be disposed in the drum unit 68.

The developing unit 70 includes the developing roller 71, a toner conveyance roller (toner supply roller) (not illustrated), a developing blade (not illustrated), a developing coupling 72, and a developing frame 73. The developing roller 71 supplies toner stored in a toner storage chamber disposed in the developing frame 73, to the photosensitive drum 61; and develops the electrostatic latent image formed on the photosensitive drum 61, into a toner image. The toner conveyance roller supplies the toner stored in the toner storage chamber, to the developing roller 71. The developing blade regulates the layer thickness of toner borne by the developing roller 71. The developing roller 71 and the toner conveyance roller are driven by the driving force applied from the apparatus body 1A to the developing coupling 72.

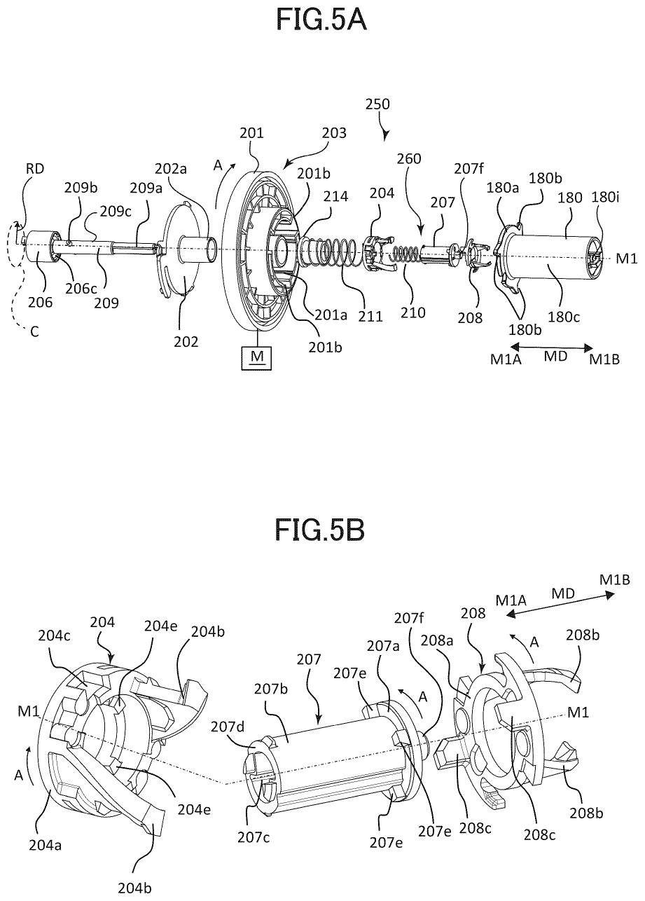

As illustrated in FIG. 4, the drum coupling 63 includes a circular hole portion 63a and projection portions 63e, which will be described in detail below. Specifically, two projection portions 63e are disposed at positions separated from each other by 180 degrees in a circumferential direction around a rotation axis M1. In each projection portion 63e, a driving-force receiving portion 63b and a brake-force receiving portion 63c are formed. The circular hole portion 63a can engage with a positioning boss 180i formed in a drum driving coupling 180 of a below-described driving-force transmission unit 203. The circular hole portion 63a and the positioning boss 180i engage with each other, so that the axis of the driving-force transmission unit 203 and the axis of the drum coupling 63 are aligned with each other. The driving-force receiving portion 63b receives driving force from the driving-force transmission unit 203, and the brake-force receiving portion 63c receives brake force from a below-described brake-force applying unit 260 (see FIG. 5A). The driving-force receiving portion 63b is positioned upstream of the brake-force receiving portion 63c in a direction indicated by an arrow A, which is a rotational direction of the drum unit 68. In the present embodiment, two driving-force receiving portions 63b and two brake-force receiving portions 63c are formed.

### Main-Body Coupling Mechanism

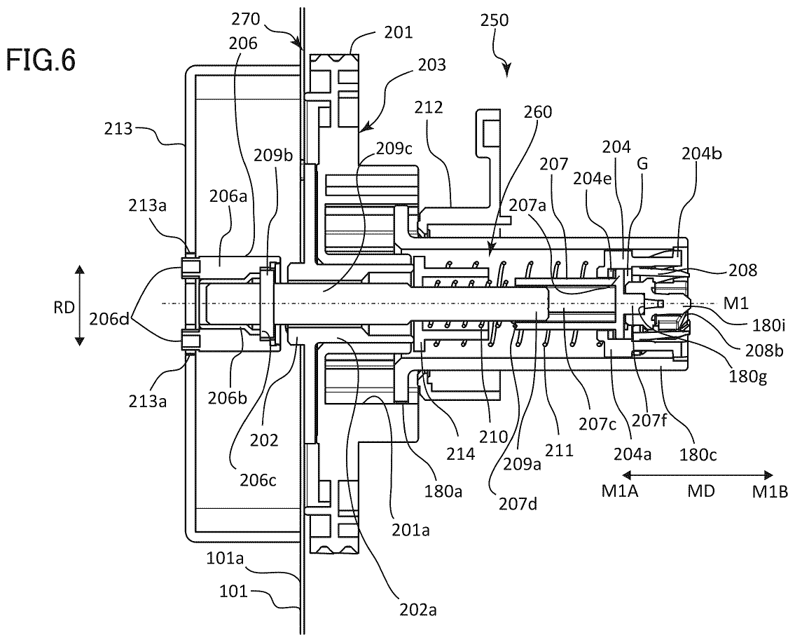

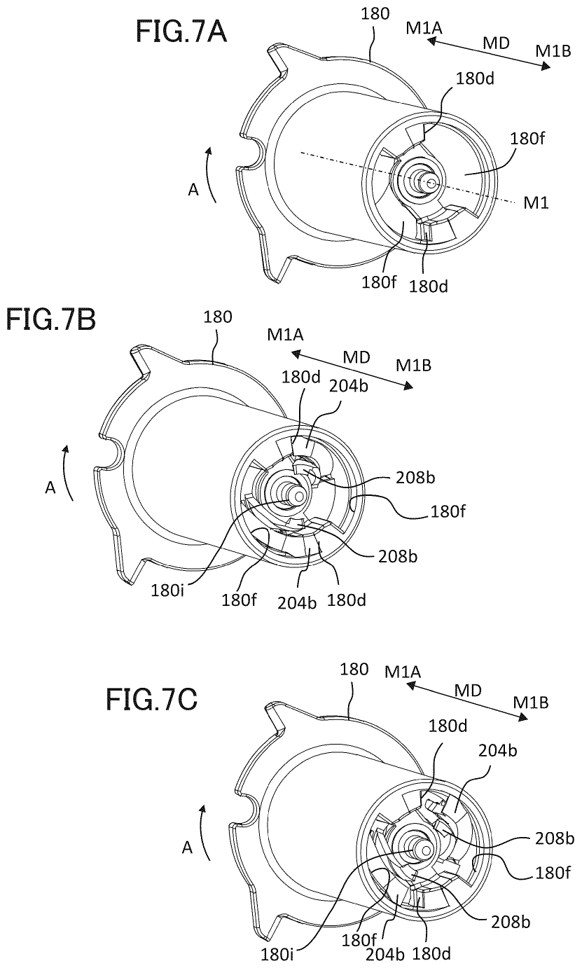

Next, with reference to FIGS. 5A to 7C, a configuration of a main-body coupling mechanism 250 disposed in the apparatus body 1A will be described. FIG. 5A is an exploded perspective view illustrating the main-body coupling mechanism 250. FIG. 5B is an exploded perspective view illustrating a first brake-engagement member 204, a second brake-engagement member 208, and a brake transmission member 207. FIG. 6 is a cross-sectional view illustrating the main-body coupling mechanism 250. FIG. 7A is a perspective view illustrating the drum driving coupling 180. FIG. 7B is a perspective view illustrating the drum driving coupling 180 and coupling engagement portions 204b and 208b. FIG. 7C is a perspective view illustrating a state where the coupling engagement portions 204b and 208b rotate in a through-hole 180f.

As illustrated in FIG. 5A, the main-body coupling mechanism 250 includes the driving-force transmission unit 203 that serves as a driving-force transmission portion, the brake-force applying unit 260 that serves as a brake-force applying portion, and a brake portion 206. As illustrated in FIG. 6, the apparatus body 1A includes a driving frame 101 that is a fixing member, and a shaft receiving member 202 that is fixed to the driving frame 101.

The driving frame 101 that serves as a frame member is constituted by a metal plate, and includes an extending surface 101a that extends in a radial direction RD. The radial direction RD is an intersecting direction that intersects (at right angles) an axis direction MD. Note that the radial direction RD is a radial direction of an imaginary circle C around the rotation axis M1. In the present embodiment, the radial direction RD is a direction orthogonal to the axis direction MD. The shaft receiving member 202 is fixed to the driving frame 101 such that the shaft receiving member 202 cannot rotate with respect to the driving frame 101, around the rotation axis M1. The driving frame 101 and the shaft receiving member 202 constitute a support portion 270 that rotatably supports the driving-force transmission unit 203. In addition, a brake cover 213 is supported by the driving frame 101 such that the brake cover 213 can be attached to and detached from the driving frame 101.

The rotation axis M1 of the driving-force transmission unit 203 extends in the axis direction MD, and is equal to the rotation axis of the drum coupling 63. In addition, the axis direction MD is a direction parallel to the longitudinal direction LD of the cartridge P illustrated in FIG. 3. In the following description, a direction of the axis direction MD that extends from the driving frame 101 toward a driving gear 201 of the driving-force transmission unit 203 is referred to as a second direction M2B, and a direction of the axis direction MD that extends from the driving frame 101 toward the brake portion 206 is referred to as a first direction MIA. The first direction MIA and the second direction MIB are directions opposite to each other.

The shaft receiving member 202 includes a cylindrical portion 202a formed cylindrically and extending in the second direction MIB. The driving-force transmission unit 203 includes the driving gear 201 and the drum driving coupling 180. The driving gear 201 includes a fitting portion 201a and a plurality of (three in the present embodiment) recess portions 201b. The fitting portion 201a is recessed in the first direction MIA. The recess portions 201b are formed in the fitting portion 201a, and recessed in the radial direction RD. The three recess portions 201b are formed at regular intervals in a circumferential direction around the rotation axis M1. The driving gear 201 is rotatably supported by the cylindrical portion 202a of the shaft receiving member 202, and is rotated by the driving force transmitted from a motor M. Note that driving-force transmission members, such as gears, may be disposed in a driving-force transmission path between the motor M and the driving gear 201.

The drum driving coupling 180 includes a cylindrical portion 180c, a flange portion 180a, and the positioning boss 180i. The cylindrical portion 180c is formed cylindrically, and extends in the axis direction MD. The flange portion 180a is formed at an end portion of the cylindrical portion 180c in the first direction MIA, and the positioning boss 180i is formed at an end portion of the cylindrical portion 180c in the second direction MIB. In the flange portion 180a, a plurality of (three in the present embodiment) projection portions 180b are formed so as to project in the radial direction RD. The flange portion 180a fits in the fitting portion 201a of the driving gear 201 in the first direction MIA, and each projection portion 180b engages with a corresponding one of the recess portions 201b of the above-described driving gear 201. Thus, the drum driving coupling 180 rotates around the rotation axis M1, together with the driving gear 201. The positioning boss 180i engages with the circular hole portion 63a (see FIG. 4) of the drum coupling 63 in a state where the cartridge P is attached to the apparatus body 1A.

As illustrated in FIG. 7A, driving-force transmission surfaces 180d and 180d, and through-holes 180f and 180f are formed around the positioning boss 180i of the drum driving coupling 180. The through-holes 180f and 180f pass through the drum driving coupling 180 in the axis direction MD. The driving-force transmission surfaces 180d and 180d are separated from each other by 180 degrees in a circumferential direction around the rotation axis M1. The through-holes 180f and 180f are also separated from each other by 180 degrees in a circumferential direction around the rotation axis M1. The driving-force transmission surfaces 180d and 180d can engage with the driving-force receiving portions 63b of the drum coupling 63.

As illustrated in FIG. 5A, the brake-force applying unit 260 that serves as a brake-force applying portion includes a brake transmission shaft 209, a spring holding member 214, the first brake-engagement member 204, and the second brake-engagement member 208. In addition, the brake-force applying unit 260 also includes a brake transmission member 207, a brake engagement spring 211, and a drum-driving coupling spring 210. The spring holding member 214, the first brake-engagement member 204, the second brake-engagement member 208, the brake transmission member 207, the brake engagement spring 211, and the drum-driving coupling spring 210 are disposed in the internal space of the cylindrical portion 180c of the drum driving coupling 180.

As illustrated in FIGS. 5A and 6, the brake transmission shaft 209 includes a shaft portion 209c extending in the axis direction MD, an engagement pin 209b fixed to the shaft portion 209c and extending in the radial direction RD, and a groove portion 209a formed in the shaft portion 209c and extending in the axis direction MD. The shaft portion 209c passes through the cylindrical portion 202a of the shaft receiving member 202, and rotatably supports the below-described spring holding member 214. In other words, the brake transmission shaft 209 that serves as a through member passes through the extending surface 101a in the axis direction MD. That is, the brake transmission shaft 209 extends from one side of the extending surface 101a to the other side of the extending surface in the axis direction MD. More specifically, the extending surface 101a has an opening, and the brake transmission shaft 209 extends through the opening of the extending surface 101a in the axis direction MD. The engagement pin 209b is disposed in a downstream end portion of the brake transmission shaft 209 in the first direction MIA. The groove portion 209a is formed in an upstream end portion of the brake transmission shaft 209 in the first direction MIA. Thus, the engagement pin 209b and the groove portion 209a are disposed opposite each other across the extending surface 101a of the driving frame 101 in the axis direction MD.

The engagement pin 209b is engaged with an engagement hole 206c formed in an inner ring 206b of the brake portion 206. Thus, the inner ring 206b and the brake transmission shaft 209 rotate together around the rotation axis M1. The brake portion 206 includes a housing 206a and the inner ring 206b that serves as a rotary member; and is positioned in the axis direction MD, by the engagement pin 209b. The housing 206a includes a projection portion 206d that engages with an engagement hole portion 213a formed in the brake cover 213. Thus, the housing 206a is prevented from rotating around the rotation axis M1.

In a case where the brake transmission shaft 209 rotates, the inner ring 206b, which rotates together with the brake transmission shaft 209, rotates while receiving brake force (load) applied from the housing 206a in the rotational direction. The method of generating the brake force may be appropriately selected from a method that uses friction, a method that uses viscosity, and the like. For example, a torque limiter may be used in the brake portion 206. The torque limiter uses, for example, the frictional force between a built-in spring and an inner ring, and thereby limits the torque transmitted from the input side to the output side, at a predetermined limit value. In the torque limiter, since the brake force is hardly applied if the predetermined limit value is exceeded, the brake force can be applied only when the torque is low. Thus, the brake force is not applied if the torque exceeds the limit value. In another case, a rotary damper may be used in the brake portion 206. The rotary damper uses brake force produced by the viscosity resistance of oil.

The groove portion 209a is formed by performing the spline processing on the shaft portion 209c. The groove portion 209a may be a plurality of groove portions formed in a circumferential direction around the rotation axis M1. However, the groove portion 209a may be a single groove portion. In addition, the groove portion 209a and a projection portion 207c of the brake transmission member 207 are spline-engaged with each other. The projection portion 207c projects inward from the inner circumferential surface of the brake transmission member 207 in the radial direction RD. The projection portion 207c may be a plurality of projection portions whose number is the same as the number of the groove portions 209a. Since the groove portion 209a and the projection portion 207c are spline-engaged with each other, the brake transmission member 207 rotates together with the brake transmission shaft 209, around the rotation axis M1. In addition, the brake transmission member 207 can move with respect to the brake transmission shaft 209 in the axis direction MD.

As illustrated in FIG. 5B, the brake transmission member 207 includes a shaft portion 207b and a flange portion 207a. The shaft portion 207b extends in the axis direction MD. The flange portion 207a extends in the radial direction RD, from a downstream end of the shaft portion 207b in the second direction MIB. The flange portion 207a includes a plurality of (four in the present embodiment) projections 207e that project in the first direction MIA. The plurality of projections 207e are formed at regular intervals in a circumferential direction around the rotation axis M1.

As illustrated in FIGS. 5A, 5B, and 6, the drum-driving coupling spring 210 that is a compression spring is disposed, contracted, between an end surface 207d of the brake transmission member 207 in the first direction MIA, and the spring holding member 214. The drum-driving coupling spring 210 applies repulsive force (urging force, elastic force) to the spring holding member 214 and the brake transmission member 207, in a direction in which the spring holding member 214 and the brake transmission member 207 are separated from each other.

As illustrated in FIG. 5B, the first brake-engagement member 204 includes a flange portion 204a and coupling engagement portions 204b. The coupling engagement portions 204b project, like claws, from the flange portion 204a in the second direction MIB. In the present embodiment, the first brake-engagement member 204 includes two coupling engagement portions 204b. However, the number of the coupling engagement portions 204b is not limited to a particular number.

The flange portion 204a includes projection portions 204e that engage with the projections 207e of the brake transmission member 207, and recess portions 204c. In the present embodiment, four projection portions 204e and two recess portions 204c are formed. However, the number of projection portions 204e and the number of the recess portions 204c are not limited to particular numbers. Since the projection portions 204e of the first brake-engagement member 204 are engaged with the projections 207e of the brake transmission member 207, the first brake-engagement member 204 rotates together with the brake transmission member 207, around the rotation axis M1. Note that the brake transmission member 207 can move with respect to the first brake-engagement member 204 in the axis direction MD, in a range of a below-described clearance G. Thus, the projections 207e have an engagement state where the projections 207e are engaged with the projection portions 204e, and a non-engagement state where the projections 204e are not engaged with the projection portions 204e.

The second brake-engagement member 208 includes a flange portion 208a and coupling engagement portions 208b. The coupling engagement portions 208b project, like claws, from the flange portion 208a in the second direction MIB. The coupling engagement portions 208b are disposed inside the coupling engagement portion 204b of the first brake-engagement member 204 in the radial direction RD. In the present embodiment, the second brake-engagement member 208 includes two coupling engagement portions 208b. However, the number of the coupling engagement portions 208b is not limited to a particular number. In the flange portion 208a, projection portions 208c that project in the first direction MIA are formed. Since the projection portions 208c of the second brake-engagement member 208 are engaged with the recess portions 204c of the first brake-engagement member 204, the second brake-engagement member 208 rotates together with the first brake-engagement member 204, around the rotation axis M1. In addition, the first brake-engagement member 204 and the second brake-engagement member 208 are coupled with each other such that the first brake-engagement member 204 and the second brake-engagement member 208 move together also in the axis direction MD. Thus, the first brake-engagement member 204 and the second brake-engagement member 208 may be collectively and simply referred to as brake engagement members (204, 208).

As illustrated in FIG. 6, the flange portion 207a of the brake transmission member 207 is disposed between the flange portion 204a of the first brake-engagement member 204 and the flange portion 208a of the second brake-engagement member 208 in the axis direction MD. In addition, the flange portion 207a is disposed between the flange portion 204a and the flange portion 208a in the axis direction MD, with the clearance G being formed between the flange portion 204a and the flange portion 208a.

As illustrated in FIGS. 5A and 6, the brake engagement spring 211 that is a compression spring is disposed, contracted, between the spring holding member 214 and the flange portion 204a of the first brake-engagement member 204. The brake engagement spring 211 applies repulsive force (urging force, elastic force) to the spring holding member 214 and the first brake-engagement member 204 in a direction in which the spring holding member 214 and the first brake-engagement member 204 are separated from each other. Since the spring holding member 214 is urged by the brake engagement spring 211 and the drum-driving coupling spring 210 in the first direction MIA, the spring holding member 214 is abutted against the end surface of the cylindrical portion 202a of the shaft receiving member 202.

As illustrated in FIGS. 5B and 6, the brake transmission member 207 includes a boss portion 207f that projects in the second direction MIB. The brake transmission member 207 receives the urging force of the brake engagement spring 211 via the flange portion 204a of the first brake-engagement member 204, and receives the urging force of the drum-driving coupling spring 210 directly. Thus, the boss portion 207f of the brake transmission member 207 is abutted against an abutment surface 180g of the drum driving coupling 180.

In addition, the drum driving coupling 180 also receives the urging force of the brake engagement spring 211 and the drum-driving coupling spring 210 via the brake transmission member 207, and is urged in the second direction MIB. As illustrated in FIG. 6, the flange portion 180a of the drum driving coupling 180 is abutted against a regulation portion 212 fixed to the apparatus body 1A, so that the drum driving coupling 180 is prevented from moving in the second direction MIB. Thus, the drum driving coupling 180 does not fall off from the driving gear 201. In addition, if the drum driving coupling 180 receives force from the outside in the first direction MIA, the drum driving coupling 180 moves against the urging force of the brake engagement spring 211 and the drum-driving coupling spring 210 in the first direction MIA, in the range of the above-described clearance G.

As illustrated in FIG. 7B, the coupling engagement portion 204b of the first brake-engagement member 204 and the coupling engagement portions 208b of the second brake-engagement member 208 are exposed from the through-hole 180f of the drum driving coupling 180. In a state where the cartridge P is attached to the apparatus body 1A, the coupling engagement portions 204b and 208b face the drum coupling 63 via the through-hole 180f.

The through-hole 180f is formed wider than the width of each of the coupling engagement portions 204b and 208b in a circumferential direction around the rotation axis M1. Thus, as illustrated in FIG. 7C, the coupling engagement portions 204b and 208b can rotate with respect to the drum driving coupling 180, in the range of the through-hole 180f. Coupling for Driving between Main-Body Coupling Mechanism and Drum Coupling

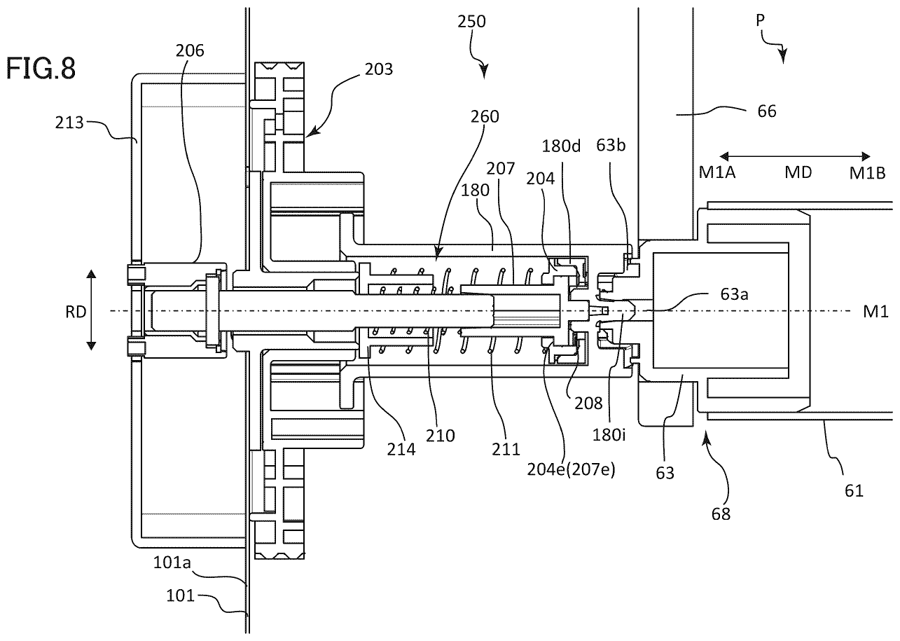

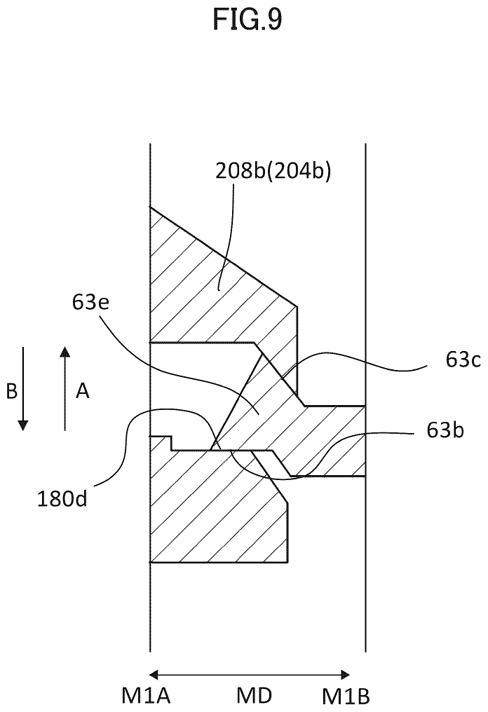

Next, the coupling for driving between the main-body coupling mechanism 250 and the drum coupling 63 will be described. FIG. 8 is a cross-sectional view illustrating a state where the main-body coupling mechanism 250 and the drum coupling 63 are engaged with each other. FIG. 9 is an enlarged cross-sectional view illustrating a vicinity of the projection portion 63e of the drum coupling 63.

As illustrated in FIG. 8, if the cartridge P is attached to the apparatus body 1A, the positioning boss 180i of the drum driving coupling 180 and the circular hole portion 63a of the drum coupling 63 engage with each other. In this state, the drum driving coupling 180 receives force from the drum coupling 63 in the first direction MIA. Thus, the drum driving coupling 180 moves in the first direction MIA, against the urging force of the brake engagement spring 211 and the drum-driving coupling spring 210. Since the boss portion 207f of the brake transmission member 207 is abutted against the abutment surface 180g of the drum driving coupling 180, the brake transmission member 207 moves together with the drum driving coupling 180 in the first direction MIA.

Since the brake transmission member 207 moves in a direction in which the above-described clearance G (see FIG. 6) decreases, the projections 207e of the brake transmission member 207 engage with the projection portions 204e of the first brake-engagement member 204, as illustrated in FIG. 8. As a result, the brake transmission member 207, the first brake-engagement member 204, the second brake-engagement member 208, and the brake transmission shaft 209, which constitute the brake-force applying unit 260, rotate together with each other around the rotation axis M1. In addition, the inner ring 206b of the brake portion 206 rotates together with the brake transmission shaft 209.

If the driving gear 201 is driven by the motor M in a direction indicated by the arrow A in FIG. 5A, the drum driving coupling 180 that fits in the driving gear 201 also rotates in the direction indicated by the arrow A. Thus, as illustrated in FIG. 9, the driving-force transmission surface 180d of the drum driving coupling 180 engages with the driving-force receiving portion 63b in the direction indicated by the arrow A, and presses the driving-force receiving portion 63b in the direction indicated by the arrow A. That is, the drum driving coupling 180 is an example of an engagement member that can engage with the driving-force receiving portion 63b of the drum unit 68. The driving-force receiving portion 63b receives the driving force (rotational force) in the direction indicated by the arrow A, so that the drum unit 68, which includes the photosensitive drum 61 and the drum coupling 63, rotates in the direction indicated by the arrow A, as illustrated in FIG. 4. The direction indicated by the arrow A serves as a first rotational direction.

On the other hand, since the photosensitive drum 61 and the drum coupling 63 rotate in the direction indicated by the arrow A, the brake-force receiving portion 63c of the drum coupling 63 engages with the coupling engagement portions 204b and 208b. In other words, the first brake-engagement member 204 and the second brake-engagement member 208 engage with the brake-force receiving portion 63c of the drum unit 68 in a direction indicated by an arrow B that is opposite to the direction indicated by the arrow A. The direction indicated by the arrow B serves as a second rotational direction. That is, the first brake-engagement member 204 and the second brake-engagement member 208 are an example of a brake engagement member that engages with the drum unit 68. The driving force from the motor M is transmitted from the drum driving coupling 180 to the drum coupling 63, and from the drum coupling 63 to the brake engagement members (204, 208). As described above, the first brake-engagement member 204, the second brake-engagement member 208, the brake transmission member 207, the brake transmission shaft 209, and the inner ring 206b of the brake portion 206 are coupled for driving with each other in a rotational direction around the rotation axis M1. In addition, while rotating around the rotation axis M1 with respect to the housing 206a, the inner ring 206b generates brake force for applying the load to the rotation of the photosensitive drum 61. The brake force is applied to the brake-force receiving portion 63c via the brake-force applying unit 260, which includes the first brake-engagement member 204 and the second brake-engagement member 208.

Thus, the drum coupling 63 is rotated in the direction indicated by the arrow A, by the driving force received from the drum driving coupling 180, while receiving appropriate load (brake force) from the first brake-engagement member 204 and the second brake-engagement member 208. That is, the torque necessary for rotating the drum coupling 63 increases due to the load (brake force) generated by the brake portion 206. As a result, the torque necessary for the drum driving coupling 180 to rotate the drum unit 68 is made not too low but appropriate, so that the rotation of the drum unit 68 becomes stable. That is, the unstable rotation of the drum unit 68, such as the abrupt fast rotation of the drum unit 68 due to the change in the driving force received from the drum driving coupling 180, can be prevented.

In addition, in the present embodiment, the brake portion 206 is disposed opposite the drum driving coupling 180 and the drum coupling 63 across the extending surface 101a of the driving frame 101 in the axis direction MD. In addition, the driving-force transmission unit 203, the brake portion 206, and the brake-force applying unit 260 are disposed on the same side with respect to the drum unit 68 in the axis direction MD. In addition, the brake portion 206 is covered by the brake cover 213 that serves as a cover member that can be attached to and detached from the driving frame 101. If part of the exterior of the apparatus body 1A and the brake cover 213 are removed, the brake portion 206 is exposed to the outside of the apparatus body 1A. Thus, it is possible to access the brake portion 206 and perform the replacement work or the like on the brake portion 206, so that the maintainability increases. That is, in the present embodiment, it is possible to easily access the brake portion 206 without removing another member of the main-body coupling mechanism 250, such as the drum driving coupling 180, so that the maintainability increases. Note that in the present embodiment, if part of the exterior of the apparatus body 1A and the brake cover 213 are removed, the brake portion 206 is exposed to the outside of the apparatus body 1A. However, the present disclosure is not limited to this. For example, the brake cover 213 may constitute part of the exterior of the apparatus body 1A, and the brake portion 206 may be exposed to the outside of the apparatus body 1A by only removing the brake cover 213.

### Second Embodiment

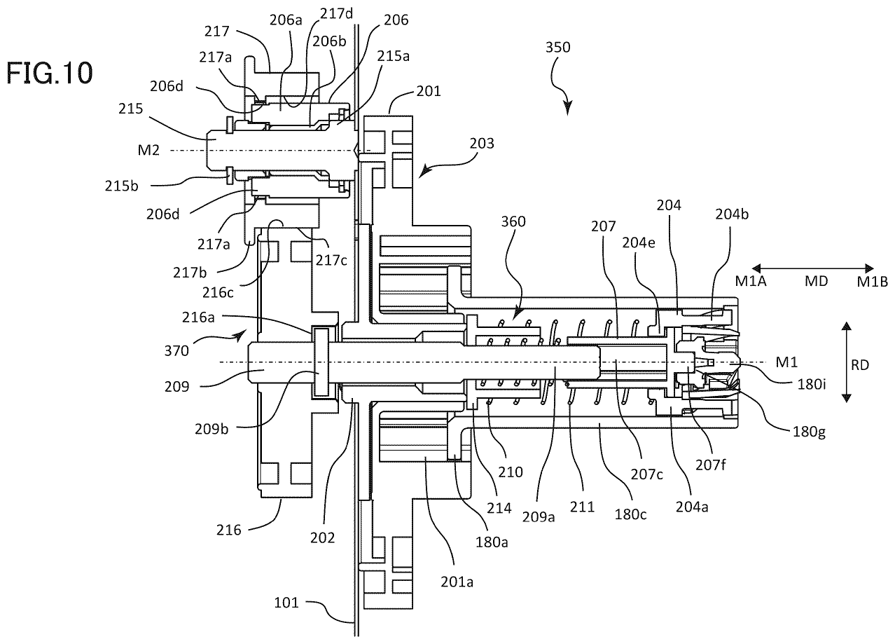

Next, a second embodiment of the present disclosure will be described. In the second embodiment, the brake portion 206 of the first embodiment is disposed at a position different from the position of the rotation axis M1 of the drum coupling 63. Thus, the same components as those of the first embodiment are omitted in a drawing, or will be described with the same symbols given to the drawing. FIG. 10 is a cross-sectional view illustrating a main-body coupling mechanism 350 of the second embodiment.

The main-body coupling mechanism 350 includes a driving-force transmission unit 203, a brake-force applying unit 360 that serves as a brake-force applying portion, and a brake portion 206. The brake-force applying unit 360 includes gears 216 and 217, a brake transmission shaft 209, a spring holding member 214, a first brake-engagement member 204, and a second brake-engagement member 208. In addition, the brake-force applying unit 360 also includes a brake transmission member 207, a brake engagement spring 211, and a drum-driving coupling spring 210.

In addition, a shaft 215 is fixed to the driving frame 101. The shaft 215 extends along a rotation axis M2 that extends in parallel with the rotation axis M1, and that is positioned at a position different from the position of the rotation axis M1 in the radial direction RD. In addition, an inner ring 206b of the brake portion 206 is fixed to the shaft 215. The brake portion 206 includes a housing 206a, and the inner ring 206b accommodated in the housing 206a. That is, the brake portion 206 is disposed at a position shifted from the rotation axis M1 in the radial direction RD. The inner ring 206b is non-rotatably attached to the shaft 215 via a rotation prevention portion 215a of the shaft 215. The housing 206a can rotate relative to the inner ring 206b.

When the housing 206a rotates relative to the inner ring 206b, the housing 206a rotates while receiving brake force (load) from the inner ring 206b in the rotational direction. The method of generating the brake force may be appropriately selected from a method that uses friction, a method that uses viscosity, and the like. For example, a torque limiter may be used in the brake portion 206.

The housing 206a includes a projection portion 206d. The projection portion 206d engages with an engagement portion 217a formed in the gear 217, so that the housing 206a rotates together with the gear 217. That is, the housing 206a and the gear 217 can rotate about the rotation axis M2, which serves as an axis. For example, the projection portion 206d and the engagement portion 217a are spline-engaged with each other.

The gear 217 includes a gear portion 217c, a flange portion 217b, and an accommodating portion 217d that accommodates the brake portion 206. The gear portion 217c meshes with a gear portion 216c of the gear 216. The accommodating portion 217d is disposed inside the gear portion 217c in the radial direction RD. That is, the accommodating portion 217d is disposed closer to the rotation axis M2 than the gear portion 217c is. The gear 217 is prevented from moving in the first direction MIA, by a separation prevention member 215b attached to the shaft 215. Thus, the gear 217 is prevented from falling off from the shaft 215. The flange portion 217b extends in the radial direction RD, and prevents the gear 216 from moving in the first direction MIA.

The gear 216 is rotatably supported by the brake transmission shaft 209, and includes the gear portion 216c and an engagement portion 216a. As described above, the gear 216 is prevented from moving in the first direction MIA, by the flange portion 217b; and is prevented from falling off from the brake transmission shaft 209. The engagement portion 216a is engaged with an engagement pin 209b of the brake transmission shaft 209. Thus, the gear 216 and the brake transmission shaft 209 rotate together around the rotation axis M1.

As described above, in the present embodiment, the first brake-engagement member 204, the second brake-engagement member 208, the brake transmission member 207, the brake transmission shaft 209, the gears 216 and 217, and the housing 206a of the brake portion 206 are coupled for driving with each other. That is, the gears 216 and 217 constitute a connection portion 370 that connects the brake portion 206 and the brake transmission shaft 209, and that transmits the rotation of the brake transmission shaft 209 to the brake portion 206. In addition, the brake portion 206 is disposed opposite the drum driving coupling 180 and the drum coupling 63 across the driving frame 101 in the axis direction MD. In addition, the driving-force transmission unit 203, the brake portion 206, and the brake-force applying unit 360 are disposed on the same side with respect to the drum unit 68 in the axis direction MD. In addition, while rotating around the rotation axis M2 with respect to the inner ring 206b, the housing 206a generates brake force for applying the load to the rotation of the photosensitive drum 61. The brake force applies to the brake-force receiving portion 63c via the brake-force applying unit 360, which includes the first brake-engagement member 204 and the second brake-engagement member 208.

As a result, the drum coupling 63 is rotated in the direction indicated by the arrow A, by the driving force received from the drum driving coupling 180, while receiving appropriate load (brake force) from the brake portion 206 via the brake-force applying unit 360. That is, the torque necessary for rotating the drum coupling 63 increases due to the load (brake force) generated by the brake portion 206. As a result, the torque necessary for the drum driving coupling 180 to rotate the drum unit 68 is made not too low but appropriate, so that the rotation of the drum unit 68 becomes stable.

In addition, also in the present embodiment, the brake portion 206 is covered by the brake cover 213 (see FIG. 8) that can be attached to and detached from the driving frame 101. If part of the exterior of the apparatus body 1A and the brake cover 213 are removed, the brake portion 206 is exposed to the outside of the apparatus body 1A. Thus, it is possible to access the brake portion 206 and perform the replacement work or the like on the brake portion 206, so that the maintainability increases.

In addition, in the present embodiment, the housing 206a of the brake portion 206 and the brake transmission shaft 209 are coupled for driving with each other by the gears 216 and 217, and the rotation axis M2 of the housing 206a and the rotation axis M1 of the brake transmission shaft 209 are shifted from each other in the radial direction RD. The gear 217 is disposed between the gear 216, which rotates together with the brake transmission shaft 209, and the housing 206a of the brake portion 206 in the driving-force transmission path (driving-force transmission direction). Thus, the flexibility in arrangement of the brake portion 206 can be increased.

In addition, in the present embodiment, the gear portion 216c of the gear 216 that serves as a first gear has the first number of teeth, and the gear portion 217c of the gear 217 that serves as a second gear has the second number of teeth different from the first number of teeth. The second number of teeth is made smaller than the first number of teeth, so that the brake force generated in the brake portion 206 can be increased and transmitted to the brake transmission shaft 209. Thus, the brake portion 206 can be downsized, and the apparatus body 1A can be downsized and reduced in cost.

### Other Embodiments

Note that in any one of the above-described embodiments, the cartridge P includes the drum unit 68 and the developing unit 70. That is, the cartridge P includes the photosensitive drum 61 and the developing roller 71. However, the configuration of the cartridge attached to and detached from the printer 1 is not limited to the above-described configuration.

For example, in a modification of the present embodiment, the drum unit 68 and the developing unit 70 may be formed as respective cartridges separate from each other. In such a modification, the drum unit 68 includes the photosensitive drum 61 and the drum coupling 63. The drum unit 68 can be regarded as a process cartridge that does not include the developing unit 70.

In addition, the driven member to which the driving force and the brake force are transmitted from the main-body coupling mechanism 250 or 350 may be a member other than the drum unit 68 of the cartridge P. For example, the driven member may be the driving roller 46 of the transfer unit 40. In addition, the above-described main-body coupling mechanism 250 or 350 may be applied to a developing coupling disposed on the apparatus body 1A side and used for driving the developing roller 71 of the cartridge P.

In addition, although the embodiments have been described for the case where the electrophotographic printer 1 is used, the present disclosure is not limited to this. For example, the present disclosure may also be applied to an ink-jet image forming apparatus that forms images on sheets by injecting ink from a nozzle.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-109144, filed Jul. 5, 2024, which is hereby incorporated by reference herein in its entirety.

What is claimed is:

1. An image forming apparatus comprising:
a detachable unit including a driven member configured to rotate; and
an apparatus body to which the detachable unit is detachably attached,
wherein the apparatus body includes:
a driving-force transmission portion configured to transmit driving force to the driven member, and including an engagement member, the engagement member being configured to rotate about a rotation axis extending in an axis direction and to engage with the driven member;
a support portion configured to support the driving-force transmission portion so that the driving-force transmission portion is rotatable, and including an extending surface extending in an intersecting direction that intersects the axis direction;
a brake portion configured to generate brake force that applies load to rotation of the driven member; and
a brake-force applying portion including a through member extending from one side of the extending surface to the other side of the extending surface in the axis direction, and a brake engagement member configured to engage with the driven member, the brake-force applying portion being configured to apply the brake force to the driven member via the through member and the brake engagement member by the brake engagement member engaging with the driven member, and
wherein the brake portion is disposed opposite the driving-force transmission portion across the extending surface in the axis direction.

2. The image forming apparatus according to claim 1, wherein the driving-force transmission portion, the brake portion, and the brake-force applying portion are disposed on the same side with respect to the driven member in the axis direction.

3. The image forming apparatus according to claim 1, wherein the driven member is configured to rotate in a first rotational direction by driving force transmitted from the driving-force transmission portion,
wherein the engagement member is configured to engage with the driven member in the first rotational direction, and
wherein the brake engagement member engages with the driven member in a second rotational direction opposite to the first rotational direction.

4. The image forming apparatus according to claim 1, wherein the engagement member includes a cylindrical portion formed cylindrically, and
wherein the brake engagement member is disposed in an internal space of the cylindrical portion.

5. The image forming apparatus according to claim 1, wherein the engagement member, the through member, and the brake engagement member are configured to rotate about the rotation axis.

6. The image forming apparatus according to claim 1, wherein the apparatus body includes a cover member configured to be attached to and detached from the support portion, and
wherein the brake portion is configured to be exposed to an outside of the apparatus body by the cover member being removed from the support portion.

7. The image forming apparatus according to claim 6, wherein the support portion includes:
a frame member including the extending surface and configured to detachably support the cover member; and
a shaft receiving member fixed to the frame member and configured to support the driving-force transmission portion and the through member so that the driving-force transmission portion and the through member are rotatable.

8. The image forming apparatus according to claim 1, wherein the brake portion includes a torque limiter.

9. The image forming apparatus according to claim 1, wherein the brake portion includes a rotary member configured to rotate about the rotation axis.

10. The image forming apparatus according to claim 1, wherein the through member is configured to rotate about the rotation axis,
wherein the brake portion is disposed in a position shifted from the rotation axis in a direction that intersects the axis direction, and
wherein the brake-force applying portion includes a connection portion configured to connect the brake portion and the through member, the connection portion transmitting rotation of the through member to the brake portion.

11. The image forming apparatus according to claim 10, wherein the connection portion includes:
a first gear including a first number of teeth; and
a second gear including a second number of teeth different from the first number of teeth and configured to mesh with the first gear.

12. The image forming apparatus according to claim 11, wherein the first gear is configured to rotate together with the through member,
wherein the second gear is disposed between the first gear and the brake portion, and
wherein the second number of teeth is smaller than the first number of teeth.

13. The image forming apparatus according to claim 11, wherein the second gear includes:
a gear portion configured to rotate about an axis parallel with the rotation axis and including the second number of teeth; and
an accommodating portion disposed closer to the axis than the gear portion is, and configured to accommodate the brake portion.

14. The image forming apparatus according to claim 1, wherein the driven member includes a photosensitive drum configured to bear a toner image.

15. The image forming apparatus according to claim 14, wherein the detachable unit includes:
a tray configured to be drawn from the apparatus body; and
a cartridge including the photosensitive drum, the cartridge being detachably supported by the tray.
